(19) United States
(12) Patent Application Publication
(10) Pub. No.: US 2024/0054331 A1
(43) Pub. Date: Feb. 15, 2024

(54) SOLVING OPTIMIZATION PROBLEMS USING SPIKING NEUROMORPHIC NETWORK

(71) Applicant: Intel Corporation, Santa Clara, CA (US)

(72) Inventor: Narayan Srinivasa, San Jose, CA (US)

(73) Assignee: Intel Corporation, Santa Clara, CA (US)

(21) Appl. No.: 18/489,327

(22) Filed: Oct. 18, 2023

(51) Int. Cl. G06N 3/063; G06N 3/049

(52) U.S. Cl. CPC G06N 3/063; G06N 3/049

(57) ABSTRACT

A spiking neuromorphic network may be used to solve an optimization problem. The network may include primary neurons. The state of a primary neuron may be a value of a corresponding variable of the optimization problem. The primary neurons may update their states and change values of the variables. The network may also include a cost neuron that can compute, using a cost function, costs based on values of the variables sent to the cost neuron in the form of spikes from the primary neurons. The network may also include a minima neuron for determining the lowest cost and an integrator neuron for tracking how many computational steps the primary neurons have performed. The minima neuron or integrator neuron may determine whether convergence is achieved. After the convergence is achieved, the minima neuron or integrator neuron may instruct the primary neurons to stop computing new values of the variables.

Acknowledgments. This work is supported by U.S. Department of Energy, Office of Science (MICS Office and LDRD) under contract DE-AC03-76SF00098 and an NSF grant CCR-0305879.

### 1 INTRODUCTION

Data clustering, also called cluster analysis, is an active research area with a long history (see [21, 24, 14, 23]), from the K-means methods [25, 26, 22] and hierarchical clustering algorithms in 1960s-1970s to the present-day more complex methods such as those based on Gaussian mixtures [28] and other model-based methods [1], graph partitioning methods [31, 19, 32, 29], and methods developed by the database community (see the summary in [20]).

The essential task of data clustering is partitioning data points into disjoint clusters so that (P1) objects in the same cluster are similar, (P2) objects in different clusters are dissimilar. When data objects distribute as compact clumps which are well separated, clusters are well defined and we refer to those well-defined clusters as natural clusters, When the clumps are not compact or when clumps overlap with each other, clusters are not well defined; a clear and meaningful definition of clusters then becomes crucial.

Existing clustering methods typically attempt to satisfy one of the two requirements above. K-means algorithm, for example, attempts to ensure that data point in the same cluster are similar which is (P1), while the graph partitioning methods RatioCut and NormalizedCut attempt to ensure that objects in different cluster are maximally different, which is (P2).

In this paper we introduce MinMaxCut, a graph partitioning based clustering algorithm which incorporate (P1) and (P2) simultaneously. We formally state them as the following min-max clustering principle: data should be grouped into clusters such that the similarity or association across clusters is minimized, while the similarity or association within each cluster is maximized (see [14, 35] for recent studies of clustering objective functions).

Clustering algorithms such as K-means and those based on Gaussian mixtures require the coordinates/attributes of each object explicitly. Graph partitioning algorithm requires only the pairwise similarities between objects. Given the pairwise similarity S=(sᵢⱼ), where sᵢⱼ indicates the similarity between objects i and j, we may consider S as the adjacency matrix of a weighted graph G, hence the data clustering problem becomes a graph partition problem. (Splitting a dataset into two is rephrased as culling a graph into two subgraphs; cutting a graph into two very imbalanced subgraphs is referred to as skewed cut; the boundary between two subgraphs is sometimes called cut.)

Cluster analysis is applied to large amount of data with a variety of distributions/shapes for the clusters. Using the similarity metric, more complex shaped distributions can be accommodated. For example K-means favors spherically shaped clusters, while hierarchical agglomerative clustering can produce elongate-shaped clusters by using single-linkage. Using similarity-based graph partitioning, the connectivity between objects becomes most important, instead of their shape in a Euclidean space which is very hard to model.

The min-max clustering principle favors the objective function optimization approach, i.e. clusters are obtained by optimizing an appropriate objective function. This is mathematically more principled approach, in contrast to procedure-oriented clustering methods, such as the hierarchical algorithms.

In the following we briefly summarize the results obtained in this paper, which also serve as the outline of the paper. In § 2, we discuss the MinMaxCut for K=2 case. We first show that the continuous solution of the cluster membership indicator vector is the eigenvector of the generalized Laplacian matrix of the similarity matrix. Related work on spectral graph clustering, the RatioCut [19] and the NormalizedCut [32] are discussed in § 2.1. Using random graph model, we show that MinMaxCut tends to produce balanced clusters while earlier methods do not (see § 2.2). The cluster balancing power of MinMaxCut can be softened or hardened by a slight generalization of the clustering objective function (see § 2.3). In § 2.4, we define the cohesion of a dataset/graph as the optimal value of MinMaxCut objective function when the dataset is split into two. We prove important lower and upper bounds for the cohesion value. Experiments on clustering internet newsgroups are presented in § 2.5. which show the advantage of MinMaxCut compared with existing methods. In § 2.6 we derive the conditions for possible skewed clustering for MinMaxCut and NormalizedCut which shows the balancing power of MinMaxCut. In § 2.7, we show the MinMaxCut linkage is useful for further refinement of clusters obtained from MinMaxCut. The linkage differential ordering can further improve the clustering results (see § 2.8). In § 2.9, we discuss the clustering of a contingency table which can be viewed as a weighted bipartite graph. The simultaneous clustering of rows and columns of the contingency table can be done in much the same way as in 2-way clustering of § 2.

In § 3, we discuss MinMaxCut for K>2 cases. We show K-way MinMaxCut leads to the more refined or subtle cluster balance, the similarity-weighted size balance in § 3.1. In § 3.2. the importance of K′ eigenvectors are noted with the generalized lower and upper bounds of optimal value of the objective function. The K-way clustering requires two stages, the initial clustering and refinement. In § 3.3, three methods of initial clustering are briefly explained, the eigenspace K-means, the divisive and agglomerative clusterings. The cluster refinement algorithms based on MinMaxCut objective functions are outline in § 3.4.

In § 4, the divisive MinMaxCut as a K-way clustering method is explained in detail. We first prove the monotonicity of MinMaxCut and K-means objective function w.r.t. to cluster merging and splitting in § 4.1. In § 4.2, we outline the cluster selection methods: those based on the size-priority, average similarity, cohesion and temporary objectives. Stopping criteria are outlined in § 4.3. In § 4.4, we discuss objective function saturation, a subtle issue in objective function optimization based approaches. In § 4.5, results of comprehensive experiments on newsgroup are presented which show the average similarity as a better cluster selection method. Our results also show the importance of MinMaxCut based refinement after the initial clusters are obtained in the divisive clustering. This indicates the appropriateness of the MinMaxCut objective function. In § 5, summary and discussions results are given. Some preliminary results [10, 8] of this paper were previously represented in conferences.

### 2 Two-Way MinMaxCut

Given pairwise similarities or associations for a set of n data objects specified in S=(sᵢⱼ), we wish to cluster the data objects into two clusters A, B based on the following min-max clustering principle: data points are grouped into clusters such that between-cluster associations are minimized while within-cluster associations are maximized. The association between A, B is the sum of pairwise associations between the two clusters, s(A,B)=Σ_{i∈A,j∈B}sᵢⱼ. The association within cluster A is s(A,A)=Σ_{i∈A,j∈A}sᵢⱼ; s(B, B) is analogously defined. The min-max clustering principle requires

min s(A, B), max s(A, A), max s(B, B). (1)

These requirements are simultaneously satisfied by minimizing the objective function [10],

$${J}_{MMC} = \frac{s ( A , B )}{s ( A , A )} + \frac{s ( A , B )}{s ( B , B )} . \qquad ( 2 )$$

Note that there are many objective functions that satisfy Eq. (1). However, for J_{MMC}, a continuous solutions can be computed efficiently.

Clustering solution can be represented by an indicator vector q,

$${q}_{ι} = \{ \begin{matrix}a & if i ∈ A \\ - b & if i ∈ B\end{matrix} , \qquad ( 3 )$$

where a=\sqrt{d_{B}/d_{A}}, b=\sqrt{d_{A}/d_{B}},

$${d}_{A} = {\sum }_{i ∈ A} {d}_{i} , {d}_{B} = {\sum }_{i ∈ B} {d}_{i} , \qquad ( 4 )$$

and dᵢ=Σⱼsᵢⱼ is the degree of node i. Thus

q^{T}De=0, (5)

where D=diag(d₁, . . . ,dₙ). We first prove that

$${min}_{q} {J}_{MMC} ( A , B ) {max}_{q} {J}_{m} ( q ) , {J}_{m} ( q ) = \frac{{q}^{T} Sq}{{q}^{T} Dq} . \qquad ( 6 )$$

Define the indicator vector x, where

$${x}_{i} = ( {q}_{i} - \frac{a - b}{2} ) \frac{2}{a + b} = \{ \begin{matrix}1 & if {q}_{i} = a \\ - 1 & if {q}_{i} = - b\end{matrix}$$

Now

$$s ( A , B ) = \frac{1}{2} {\sum }_{ij} \frac{{( {x}_{i} - {x}_{j} )}^{2}}{4} {s}_{ij} = \frac{1}{2} {\sum }_{ij} \frac{{( {q}_{i} - {q}_{j} )}^{2}}{{( a + b )}^{2}} {s}_{ij} = \frac{{q}^{T} ( D - S ) q}{{( a + b )}^{2}} . \qquad ( 7 )$$

By definition of q in Eq. (3), we obtain

q^{T}Sq=a²s(A,A)+b²s(B,B)−2 abs(A,B). (8)

The orthogonality condition of Eq. (5) becomes

as(A,A)−bs(B,B)+(a−b)s(A,B)=0. (9)

With these relations, after some algebraic manipulation, we obtain

$${J}_{MMC} = \frac{1 + a / b}{{J}_{m} + a / b} - \frac{1 + b / a}{{J}_{m} + b / a} - 2. \qquad ( 10 )$$

Since b/a>0 is fixed, one can easily see that

$$\frac{{dJ}_{MMC}}{{dJ}_{m}} = - \frac{1 + a / b}{{( {J}_{m} + a / b )}^{2}} - \frac{1 + b / a}{{( {J}_{m} + b / a )}^{2}} < 0.$$

Hence J_{MMC} is a monotonically decreasing function of Jₘ. This proves Eq. (6).

Optimization of Jₘ(q) with the constraint that qᵢ takes discrete values {a, −b} is a bard problem. Following § 2.1, we let qᵢ take arbitrary continuous values in the interval [−1, 1]. The optimal solution for the Rayleigh quotient of Jₘ in Eq. (6) is the eigenvector q associated with the largest eigenvalue of the system

Sq=λDq. (11)

Let q=D^{-1/2}z and multiply both sides by D^{-1/2}; this equation becomes a standard eigenvalue problem:

D^{-1/2}WD^{-1/2}zₖ=λₖzₖ, λₖ=1−ζₖ, (12)

The desired solution is q₂. (The trivial solution λ₁=1 and q₁=e is discarded.) Since qₖ satisfies the orthogonality relation zₖ^{T}zₚ=qₖ^{T}Dqₚ=0 if k≠q, constraint Eq. (5) is automatically satisfied. We summarize these results as
Theorem 2.1. Clustering a dataset by optimizing the objective function Eq. (2), the optimal cluster indicators are given by the eigenvector q₂.

From Eq. (3), we can recover cluster membership by sign, i.e., A={i|q₂(i)≤0}, B={i|q₂(i)≥0}. In general, the optimal dividing point could shift away from 0; we search the dividing point i_{cut}=1, . . . ,n−1, setting

A={i|q₂(i)≤q₂(i_{cut})}, B={i|q₂(i)>q₂(i_{cut})}, (13)

such that J_{MMC(A, B)} is minimized. The corresponding A and B are the final clusters.

The computation of the eigenvectors can be done quickly via the Lanczos method [30]. A software package for this calculation, LANSO, is available online (http://www.nersc.gov/˜kewu/planso.html). Overall the computational complexity is O(n²).

### 2.1 Related Work on Spectral Graph Partition

Spectral graph partitioning is based on the properties of eigenvectors of the Laplacian matrix L=D−W, first developed by Donath and Hoffman [11] and Fiedler [16, 17]. The method becomes widely known in high performance computing area by the work of Pothen, Simon and Liu [31]. The objective of the partitioning is to minimize the MinCut objective, i.e, the cutsize (the between-cluster similarity) J_{cut}(A,B)=s(A,B) with the requirement that two subgraphs have the same number of nodes: |A|=|B|. Using indicator variable xᵤ, xᵤ={1,−1} depending on u∈A or B, the cutsize is

$$s ( A , B ) = {\sum }_{{e}_{uv} ∈ E} \frac{{( {x}_{u} - {x}_{v} )}^{2}}{4} {s}_{uv} = \frac{{x}^{T} ( D - S ) x}{2} . \qquad ( 14 )$$

Relax xᵤ from {1, −1} to continuous value in [−1, 1], minimizing s(A, B) is equivalent to solve the eigensystem

(D−S)x=ζx, (15)

Since the trivial x₁=e is associated with λ₁=0, the second eigenvector x₂, also called Fiedler vector, is the solution. Hagen and Kahng [19] remove the requirement |A|=|B| and show that the x₂ provides the continuous solution of the cluster indicator vector for the RatioCut objective function [5]

$${J}_{rcut} = \frac{s ( A , B )}{\vert A \vert} + \frac{s ( A , B )}{\vert B \vert} . \qquad ( 16 )$$

The generalized eigensystem of Eq. (15) is

(D−S)x=ζDx, (17)

which is identical to Eq. (11) with λ=1−ζ. The use of this equation has been studied by a number of authors [12, 6, 32]. Chung [6] emphasizes the advantage of using normalized Laplacian matrix which leads to Eq. (17). Shi and Malik [32] propose the NormalizedCut,

$${J}_{ncut} = \frac{s ( A , B )}{{d}_{A}} + \frac{s ( A , B )}{{d}_{B}} \qquad ( 18 )$$

where d_{A}, d_{B} defined in Eq. (4) are also called the volumes [6] of subgraphs A, B, in contrast to the sizes of A, B. A key observation is that J_{ncut} can be written as

$${J}_{ncut} = \frac{s ( A , B )}{s ( A , A ) + s ( A , B )} + \frac{s ( A , B )}{s ( B , B ) + s ( A , B )} , \qquad ( 19 )$$

since

$${d}_{A} ≡ {\sum }_{i ∈ A} {d}_{i} = {\sum }_{i ∈ A , j ∈ G} {s}_{ij} = {\sum }_{: i ∈ A} ( {\sum }_{j ∈ A} + {\sum }_{j ∈ B} ) {s}_{ij} = s ( A , A ) + s ( A , B ) ,$$

and d_{B}=s(B,B)+s(A,B). The presence of s(A, B) in the denominators of J_{ncut} indicate it is not conformal to the min-max clustering principle. In practical applications, NormalizedCut sometimes leads to unbalanced clusters (see § 2.5). MinMaxCut is developed by being conformal to the min-max clustering principle. In extensive experiments (see § 2.5), MinMaxCut consistently outperforms NormalizedCut and RatioCut.

RatioCut, NormalizedCut and MinMaxCut objective functions are first prescribed by proper motivating considerations and then q₂ is shown to be the continuous solution of the cluster indicator vectors. It should be noted that in a perturbation analysis on the case where clusters are well separated (thus clearly defined) [9], the same three objective functions can be automatically recovered as the second principal eigenvalue of the corresponding (normalized) Laplacian matrix and indicator vector of Eq. 3 are recovered. This further strengthens the connection between clustering objective functions and the Laplacian matrix of a graph.

Besides Laplacian matrix based spectral partitioning methods, other recent partitioning methods use singular value decompositions [2, 13].

### 2.2 Cluster Balance: Random Graph Model Analysis

One important feature of the MinMaxCut method is that it tends to produce balanced clusters, i.e., the resulting subgraphs have similar sizes. Here we use the random graph model [5, 3] to illustrate this point. Suppose we have a uniformly distributed random graph with n nodes. For this random graph, any two nodes are connected with probability p, 0≤p≤1. We consider the four objective functions, the MinCut, RatioCut, NormalizedCut and MinMaxCut (see § 2.1). We have the following
Theorem 2.2. For random graphs, MinCut favors highly skewed cuts. MinMaxCut favors balanced cut, i.e., both subgraphs have the same size. RatioCut and NormalizedCut show no size preferences, i.e., each subgraph could have arbitrary size.

Proof. We compute the object functions for the partition of G into A and B. Note that the number of edges between A and B are p|A∥B| on average. For MinCut, we have

J_{mincut}(A,B)=p|A∥B|

For RatioCut, we have

$${J}_{rcut} ( A , B ) = \frac{p \vert A \vert \vert B \vert}{\vert A \vert} + \frac{p \vert A \vert \vert B \vert}{\vert B \vert} = p ( \vert A \vert - \vert B \vert ) = np .$$

For NormalizedCut, since all nodes have the same degree (n−1)p,

$${J}_{ncut} ( A , B ) = \frac{p \vert A \vert \vert B \vert}{p \vert A \vert ( n - 1 )} + \frac{p \vert A \vert \vert B \vert}{p \vert B \vert ( n - 1 )} = \frac{n}{n - 1} .$$

For MinMaxCut, we have

$${J}_{MMC} ( A , B ) = \frac{\vert B \vert}{\vert A \vert - 1} + \frac{\vert A \vert}{\vert B \vert - 1} .$$

We now minimize these objectives. Clearly, MinCut favors either |A|=n−1,|B|=1 or |B|=n−1,|A|=1, both are skewed cuts. Minimizing J_{MMC}(A, B), we obtain a balanced cut: |A|=|B|=n/2:

$${min}_{A , B} {J}_{MMC} ( A , B ) = \frac{2}{1 - 2 / n} . \qquad ( 20 )$$

Both Rcut and Ncut objectives have no size dependency and no size preference.

### 2.3 Soft and Hard MinMaxCut

Clearly MinMaxCut bas a strong tendency to produce balanced clusters. Although balanced clusters are desirable, sometimes naturally occurring clusters are not necessarily balanced. Here we introduce a generalized MinMaxCut that has varying degree of cluster balancing. We define the generalized clustering objective function

$${J}_{MMC}^{( α )} = {[ \frac{s ( A , B )}{s ( A , A )} ]}^{α} + {[ \frac{s ( A , B )}{s ( B , B )} ]}^{α} \qquad ( 21 )$$

for any fixed parameter α>0.

The important property of J_{MMC}^{(α)} is that the procedure for computing the clusters remains identical to α=1 case in § 2.1, because minimization of J_{MMC}^{(α)} leads to the same problem of max Jₘ(q), i.e.,

$${min}_{q} {J}_{MMC}^{( α )} ( A , B ) {max}_{q} {J}_{m} ( q ) ,$$

for any α>0; this can be proved by repeating the proof of Eq. (6).

The generalized MinMaxCut for any α>0 still retains the cluster balancing property as one can easily show that Theorem 2.2 regarding cluster balancing on random graphs remains valid. However, the level of balancing depends on α.

If α>1, J_{MMC}^{(α)} will have stronger cluster balancing than J_{MMC}^{(α-1)}, because the larger of the two terms

$$\frac{s ( A , B )}{s ( A , A )} , \frac{s ( A , B )}{s ( B , B )} \qquad ( 22 )$$

will dominate J_{MMC}^{(α)} more, and thus min J_{MMC}^{(α>1)} will more strongly force the two terms to be equal. We call this case the hard MinMaxCut. In particular, for α>>1, we have

$${J}_{MMC}^{( α ≫ 1 )} ≃ {[ max ( \frac{s ( A , B )}{s ( A , A )} , \frac{s ( A , B )}{s ( B , B )} ) ]}^{α} \qquad ( 23 )$$

$${min}_{q} {J}_{MMC}^{( α ≫ 1 )} {min}_{q} max ( \frac{s ( A , B )}{s ( A , A )} , \frac{s ( A , B )}{s ( B , B )} ) .$$

We call this case the “minimax cut”. Minimax-cut ignores the details of the smaller term and therefore is less sensitive than J_{MMC}^{(α-1)}.

If α<1, J_{MMC}^{(α)} will have weaker cluster balancing. This case is more applicable for datasets where natural clusters are of different sizes. Here ½≤α<1 are good choices. We call this case the soft MinMaxCut.

### 2.4 Cluster Cohesion and Bounds

Given a dataset of n objects and their pairwise similarity S=(sᵢⱼ), we may partition them into two subsets in many different ways with different values of J_{MMC}. However, the optimal J_{MMC} value

$$h ( S ) ≡ {J}_{MMC}^{opt} ( S ) = {min}_{q} {J}_{MMC} ( q ; S )$$

is a well-defined quantity, although its exact value may not be easily computed.

Definition. Cluster cohesion of a dataset is the smallest value of the MinMaxCut objective function when the dataset is split into two clusters.

Cluster cohesion is a good characterization of a dataset against splitting it into two clusters. Suppose we apply MinMaxCut to split a dataset into two clusters. If J_{MMC}^{opt} thus obtained is large, this indicates the overlap between the two resulting clusters is large in comparison to the within-cluster similarity, and thus the dataset is likely a single natural cluster and should not be split.

On the other hand, if J_{MMC}^{opt}(S) is small, the overlap between the two resulting clusters is small, i.e., two clusters are well-separated, which indicates that the dataset should be split. Thus J_{MMC}^{opt} is a good indicator of cohesion of the dataset with respect to clustering. For this reason, J_{MMC}^{opt}(S) is called cluster cohesion and is denoted as h(S).

Note that h is similar to Cheeger constant [6] h₁ in graph theory, which is defined as

$${h}_{1} = {min}_{q} \frac{s ( A , B )}{min ( {d}_{A} , {d}_{B} )} = {min}_{q} max ( \frac{s ( A , B )}{{d}_{A}} , \frac{s ( A , B )}{{d}_{B}} )$$

From Eq. (19), one can see that NormalizedCut is a generalization of Cheeger constant, i.e., both terms are retained in the optimization of NormalizedCut. Using the analogy of the minimax version of MinMaxCut via Eq. (23), we may also say that h₁ is the minimax version of NormalizedCut. Since S can be viewed as the adjacency matrix of a graph G, we call h the cohesion of graph G.

For all possible graphs one may expect the cohesion value to have a large range and thus difficult to gauge. Surprisingly, cohesion for an arbitrarily weighted graph is restricted to a narrow range, as we can prove the following:
Theorem 2.4. (a) The largest cohesion value of all possible graphs (similarity matrices S) is

$${max}_{S} h ( S ) = \frac{2}{1 - 2 / n} \qquad ( 24 )$$

(b) the cohesion of a graph has the bound

$$\frac{4}{1 + {λ}_{2}} - 2 \leq h \leq \frac{2}{1 - 2 / n} \qquad ( 25 )$$

where λ₂ is from Eq. (12).

Proof. Part (a) can be proved by the following two lemmas regarding graphs. Lemma (L1): The unweighted complete graph (clique) has the cohesion of Eq. (24), same as the random graph with p=1 (see Eq. (20)). Lemma (L2): All graphs, both weighted and unweighted, have cohesion smaller than that of the complete graph. L2 is very intuitive and can be proved rigorously by starting with a clique and removing edges. Details are skipped here. Part (b) is proved by considering J_{MMC}(Jₘ, a/b) as a function of a/b and Jₘ. It can be shown that

$${J}_{MMC} ( {J}_{m} , \frac{a}{b} ) \geq {min}_{a / b} {J}_{MMC} ( {J}_{m} , \frac{a}{b} ) = \frac{4}{1 + {J}_{m}} - 2 \geq \frac{4}{1 + {λ}_{2}} - 2 \qquad ( 26 )$$

The last inequality follows from

$${J}_{m} ( q ) = \frac{{q}^{T} Sq}{{q}^{T} Dq} \leq {max}_{q} \frac{{q}^{T} Sq}{{q}^{T} Dq} = {λ}_{2} .$$

Theorem 2.4 establishes cluster cohesion J_{MMC}^{opt} as a useful quantity to characterize a dataset with the chosen similarity metric. The upper bound is useful for checking whether a partition of the dataset is within the right range.

### 2.5 Internet Newsgroups Clustering Experiments

Document clustering has been popular in analyzing text information. Here we perform experiments on newsgroup articles in 20 newsgroups (dataset available online [27]). We focus on three datasets, each bas two newsgroups:

| NG1/NG2 | NG10/NG11 | NG18/NG19 |
|---|---|---|
| NG1: alt.atheism | NG10: rec.sport.baseball | NG18: |
| | | talk.politics.mideast |
| NG2: comp.graphics | NG11: rec.sport.hockey | NG19: talk.politics.misc |

Word-document matrix X=(x₁, . . . ,xₙ) is first constructed. 2000 words are selected according to the mutual information between words and documents

$$I ( w ) = {\sum }_{x} p ( w , x ) {log}_{2} [ p ( w , x ) / p ( w ) p ( x ) ]$$

where w represents a word and x represents a document. Words are stemmed using [27]. Standard tf.idf scheme for term weighting is used and standard cosine similarity between two documents x₁, x₂: sim(x₁,x₂)=x₁·x₂/|x₁∥x₂| is used. When each document, colon of X, is normalized to 1 using L₂ norm, document-document similarities are calculated as W=X^{T}X. W is interpreted as the weight/affinity matrix of the undirected graph. From this similarity matrix, we perform the clustering as explained above.

For comparison purpose, we also consider three other clustering methods: the RatioCut the NormalizedCut and the principle direction divisive partitioning (PDDP) [2]. PDDP is based on the idea of principle component analysis (PCA) applied to the vector-space model on X. First X is centered, i.e., the average of each row (a word) is subtracted. Then the first principle direction is computed. The loadings of the documents (the projection of each document on the principle axis) form a 1-dim linear search order. This provides a heuristic very similar to the linear search order provided by the Fiedler vector. Instead of searching through to find a minimum based on some objective function, PDDP partitions data into two parts at the center of mass.

We perform these two-cluster experiments in a way similar to cross-validation. We divide one newsgroup A randomly into K₁ subgroups and the other newsgroup B randomly into K₂ subgroups. Then one of the K₁ subgroups of A is mixed with one of the K₂ subgroups of B to produce a dataset G. The graph partition methods are run on this dataset G to produce two clusters. Since the true label of each newsgroup article is known, we use accuracy, percentage of newsgroup articles correctly clustered, as a measure of success. This is repeated for all K₁k₂ pairs between A and B, and the accuracy is averaged. In this way, every newsgroup articles is used the same number of times. The mean and standard deviation of accuracy are listed.

To Table 1, the clustering results are listed for balanced cluster cases, i.e., both subgroups have about 200 newsgroup articles. MinMaxCut performs about the same as Ncut for newsgroups NG1/NG2, where the cluster overlap is small. MinMaxCut performs substantially better than Ncut for newsgroups NG10/NG11 and newsgroups NG18/NG19, where the cluster overlaps are large. MinMaxCut performs slightly better than PDDP. Rcut always performs the worst among the 4 methods and will not be studied further.

In Table 2, the clustering results are listed for unbalanced cases, i.e., one subgroup has 300 newsgroup articles and the other subgroup has 200. This is generally a harder problem due to the unbalanced prior distributions. In this case, both MinMaxCut and Ncut perform reasonably well, no clear deterioration is seen, while the performance of PDDP clearly deteriorated. This indicates the strength of MinMaxCut method using graph model. MinMaxCut consistently performs better than NormalizedCut for cases where the cluster overlaps are large.

TABLE 1
Accuracy (%) of clustering experiments using MinMaxCut,
RatioCut, NormalizedCut and PDDP. Each test set G is a
mixture of 400 news articles, 200 from each newsgroup.

| Dataset | MinMaxCut | NormalizedCut | RatioCut | PDDP |
|---|---|---|---|---|
| NG1/NG2 | 97.2 ± 1.1 | 97.2 ± 0.8 | 63.2 ± 16.2 | 96.4 ± 1.2 |
| NG10/NG11 | 79.5 ± 11.0 | 74.4 ± 20.4 | 54.9 ± 2.5 | 89.1 ± 4.7 |
| NG18/NG19 | 83.6 ± 2.5 | 57.5 ± 0.9 | 53.6 ± 3.1 | 71.9 ± 5.4 |

TABLE 2
Accuracy of clustering experiments using MinMaxCut, NormalizedCut
and PDDP. Each test set G is a mixture of 300 news articles from one
newsgroup and 200 news articles from the other newsgroup.

| Dataset | MinMaxCut | NormalizedCut | PDDP |
|---|---|---|---|
| NG1/NG2 | 97.6 ± 0.8% | 97.2 ± 0.8% | 90.6 ± 2.1% |
| NG10/NG11 | 85.7 ± 8.3% | 73.8 ± 16.6% | 87.4 ± 2.6% |
| NG18/NG19 | 78.8 ± 4.5% | 65.7 ± 0.5% | 59.6 ± 2.4% |

### 2.6 Cluster Balance: Skewed Cut Analysis

We further study the reasons that MinMaxCut consistently outperforms NormalizedCut in large overlap cases. NormalizedCut sometimes cuts out a small subgraph, because the presence of s(A, B) in the denominators helps to produce a smaller J_{ncut} value for the skewed cut than for the balanced cut.

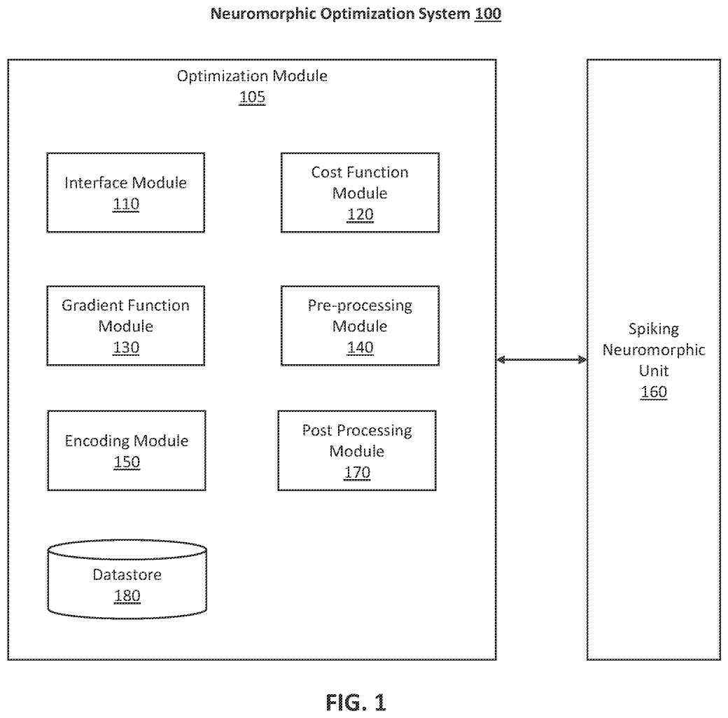

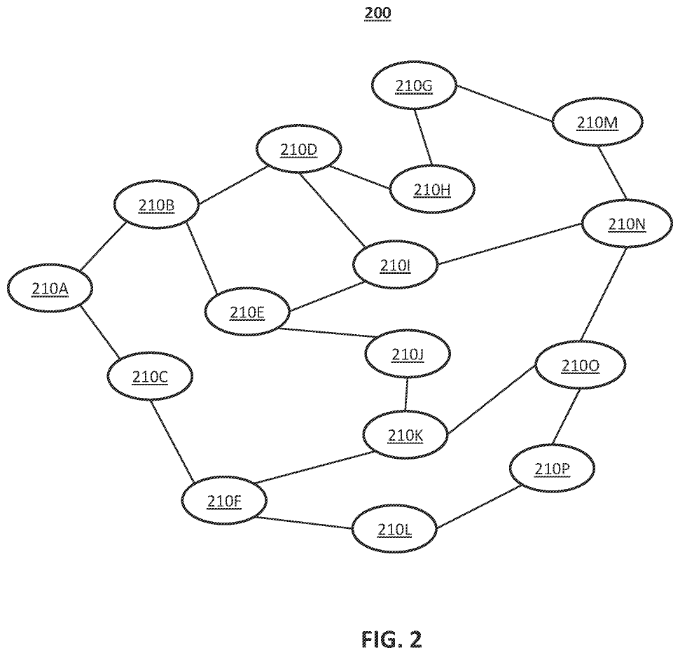

We examine several cases and one specific case is shown in FIG. 1. The cut points and relevant quantities for MinMaxCut and NormalizedCut are listed in Table 3. NormalizedCut has two pronounced valleys, and produces a skewed cut, while MinMaxCut has a single valley and gives a balanced cut. Further examination shows that in both cases, the cutsizes s(A, B) obtained in NormalizedCut are equal or bigger than the within-cluster similarity of the smaller cluster as listed in Table 3. In these cases, clearly the NormalizedCut objective [see Eq. (18)] is not appropriate. In the MinMaxCut objective, the cutsize is absent in the denominators; this provides a balanced cut.

These case studies provide some insights into those graph partition methods. Prompted by these studies, here we provide further analysis and derive general conditions under which a skewed cut will occur. Consider the balanced cases where s(A,A)≅s(B,B). Let

s(A,B)=f·(s), (s)=½(s(A,A)+s(B,B),

TABLE 3
Cutpoint, between-cluster and within-cluster similarities for
the dataset in FIG. 1.

| Method | i_{cut} | s(A,B) | s(A,A) | s(B,B) |
|---|---|---|---|---|
| J_{ncut} | 66 | 869.6 | 771.2 | 5467 |
| J_{MMC} | 150 | 1418 | 2136 | 3006 |

where f>0 is the average fraction of cut relative to within cluster associations.

In the case when the partition is optimal, A and B are exactly the partitioning result. The corresponding NormalizedCut value is

$${J}_{ncut} ( A , B ) = \frac{s ( A , B )}{s ( A , A ) + s ( A , B )} + \frac{s ( A , B )}{s ( B , B ) + s ( A , B )} ≃ \frac{2 f}{1 + f} \qquad ( 27 )$$

For a skewed partition A₁, B₁, we have s(A₁,A₁)<<s(B₁,B1), and therefore s(A_{1,}B₁)<<(B₁,B1). The corresponding J_{ncut} value is

$${J}_{ncut} ( {A}_{1} , {B}_{1} ) ≃ \frac{s ( {A}_{1} , {B}_{1} )}{s ( {A}_{1} , {A}_{1} ) + s ( {A}_{1} , {B}_{1} )} \qquad ( 28 )$$

Using NormalizedCut, a skewed or incorrect cut will happen if J_{ncut}(A₁,B₁)<J_{ncut}(A,B) Using Eqs. (27, 28), this condition is satisfied if

$$NormalizedCut : s ( {A}_{1} , {A}_{1} ) \geq ( \frac{1}{2 f} - \frac{1}{2} ) s ( {A}_{1} , {B}_{1} )$$

We repeat the same analysis using MinMaxCut and calculating J_{MMC}(A, B) and J_{MMC}(A₁, B₁). The condition for a skewed cut using MinMaxCut is MinMaxCut₁<MinMaxCut₀, which is

$$Min Max Cut : s ( {A}_{1} , {A}_{1} ) \geq \frac{1}{2 f} s ( {A}_{1} , {B}_{1} ) .$$

For large overlap case, say, f=½, the conditions for possible skewed cut are:

NormalizedCut: s(A₁,A₁)=s(B₁,B₁)≤s(A1,B1)/2,

MinMaxCut: s(A₁,A₁)=s(B₁,B₁)≤s(A1,B1). (29)

The relevant quantity is listed in Table 4. For datasets newsgroups 10-11, and newsgroups 18-19, the condition for skewed NormalizedCut is satisfied most of the time, leading to many skewed cuts and therefore lower clustering accuracy in Tables 1 and 2. For the same datasets, condition for skewed MinMaxCut is not satisfied most of time, leading to more correct cuts and therefore higher clustering accuracy. Eq. (29) is the main results of this analysis.

TABLE 4
Average values of s(A,B), s(A,A), s(B,B) and the fraction
in three datasets using MinMaxCut.

| Dataset | s(A,B) | s(A,A) | s(B,B) | f |
|---|---|---|---|---|
| NG1/NG2 | 549.4 | 1766.4 | 1412.5 | 0.346 |
| NG10/NG11 | 772.8 | 1372.8 | 1581.0 | 0.523 |
| NG18/NG19 | 1049.5 | 2093.9 | 1665.5 | 0.558 |

### 2.7 Improved MinMaxCut: Linkage-Based Refinements

So far we has discussed MinMaxCut using the eigenvectors of Eq. (11) as the continuous solution of the objective function as provided by Theorem 2.1. This is a good solution to the MinMaxCut problem, as the experiment results shown above. But this is still an approximate solution. Given a current clustering solution, we can refine it to improve the MinMaxCut objective function. There are many ways to refine a given clustering solution. In this and next subsections, we discuss two refinement strategies and show the corresponding experimental results.

Searching for optimal i_{cut} in Theorem 2.1 is equivalent to a linear search based on the order defined by sorting the elements of q₂, which we call q₂-order. Let π=(π₁, . . . ,πₙ) represent a permutation of (1, . . . , n). The q₂-order is the permutation π induced when sorting q₂(i) in increasing order, i.e., q₂(πᵢ)≤q₂(πᵢ₊1) for all i. The linear search algorithm based on π is to search for minimal J_{MMC}(A,B) as j=1, 2, . . . ,n−1, while setting clusters C₁, C₂ as

A={i|q₂(πᵢ)≤q₂(πⱼ)}, B={i|q₂(πᵢ)>q₂(πⱼ)}. (30)

The linear search implies that nodes on one side of the cut point must belong to one cluster: if q₂(i)≥q₂(j)≥q₂(k) where i, j, k are nodes, then the linear search will not allow the situation that i, k belong to one cluster and j belongs to the other cluster. Such a strict order is not necessary. In fact, in large overlap cases, we expect some nodes could be moved to the other side of the cut, lowering the overall objective function.

How to identify those nodes near the boundary of between the two clusters? For this purpose, we define linkage [symbol] as a closeness or similarity measure between two clusters (subgraphs):

[symbol]

(A,B)=s(A,B)/s(A,A)s(B,B) (31)

(This is motivated by the average linkage [symbol] (A,B)=s(A,B)/|A∥B| in hierarchical agglomerative clustering. Following the spirit of MinMaxCut, we replaced |A|, |B| by s(A, A), s(B, B)). For a single node u, its linkage to subgraph A is [symbol] (A,u)=s(A,u)/s(A,A). Now we can identify the nodes near the cut. If a node u is well inside a cluster, u will have a large linkage with the cluster, and a small linkage with the other cluster. If u is near the partition boundary, its linkages with both clusters should be close. Therefore, we define the linkage difference

Δ [symbol] (u)= [symbol] (u,A)− [symbol] (u,B). (32)

A node with small Δ [symbol] should be near the cut and is a possible candidate to be moved to the other cluster.

In FIG. 2, we show linkage difference Δ [symbol] for all nodes. The vertical line is the cut point. It is interesting to observe that not only many nodes have small Δ [symbol] , but quite a number of nodes whose Δ [symbol] have the wrong signs (e.g., Δ [symbol] (u)>0 if u∈A, or, Δ [symbol] (v)>0 if v∈B). For example, node #62 has a relatively large negative Δ [symbol] . This implies node #62 has a larger linkage to cluster B even though it is currently located in cluster A (left of the cutpoint). Indeed, if we move node #62 to cluster B, the objective function is reduced. Therefore we find a better solution.

After moving node #62 to cluster B, we try to move another node with negative Δ [symbol] from cluster A to cluster B depending on whether the objective function is lowered. In fact, we move all nodes in cluster A with negative Δ [symbol] to cluster B if the objective function is lowered. Similarly we move all nodes in cluster B with positive Δ [symbol] to cluster A. This procedure of swapping nodes is called the “linkage-based swap”. It is implemented by sorting the array s(u)Δ [symbol] (u)[s(u)=−1 if u∈A and s(u)=1 if u∈B] in decreasing order to provide a priority list and then moving the nodes, one by one. The greedy move starts from the top of the list to the last node u where s(u)Δ [symbol] (u)≥0. This swap reduces the objective function and increases the partitioning quality. In Table 5, the effects on clustering accuracy due to the swap are listed. In all cases, the accuracy increases. Note that in the large overlap cases, NG9/NG10, NG18/NG19, the accuracy increase about 10% over the MinMaxCut without refinement.

If s(u)Δ [symbol] (u)<0 but close to 0, node u is in the correct cluster, although it is close to the cut. Thus we select the smallest 5% of the nodes with s(u)Δ [symbol] (u)<0 as the candidates, and move those which reduce MinMaxCut objective to the other cluster. This is done in both cluster A and B. We call this procedure “linkage-based move”. Again, these moves reduce MinMaxCut objective and therefore improve the solution. In Table 5, their effects on improving clustering accuracy are shown. Putting together, the linkage based refinements improve the accuracy by 20%. Note the final MinMaxCut results are about 30-50% better than NormalizedCut and about 6-25% better than PDDP (see Tables 5 and 1).

TABLE 5
Improvements of clustering accuracy due to linkage-based
refinements for MinMaxCut alone, MinMaxCut plus swap, and
MinMaxCut plus swap and move over 5% smallest Δ [symbol] on both sides
of the cutpoint.

| Dataset | MinMaxCut | +Swap | +Swap+Move |
|---|---|---|---|
| NG1/NG2 | 97.2 ± 1.1% | 97.5 ± 0.8% | 97.8 ± 0.7% |
| NG10/NG11 | 79.5 ± 11.0% | 85.0 ± 8.9% | 94.1 ± 2.2% |
| NG18/NG19 | 83.6 ± 2.5% | 87.8 ± 2.0% | 90.0 ± 1.4% |

### 2.8 Improved MinMaxCut: Linkage Differential Order

Given a current clustering solution A, B, we can always compute the linkage difference Eq. (32) for every nodes. Now by sorting linkage differences we obtain an ordering which we call linkage differential ordering (LD-order).

The motivation of the LD-order is from observing linkage differences as shown in FIG. 2. We see that many nodes far away from the cut point have wrong Δ [symbol] signs, that is, they should belong to the other subgraph. This suggests that the q₂-order is not the perfect linear search order.

This prompt us to apply the linear search algorithm of Eq. (30) to the LD-order to search for optimal MinMaxCut. The results are given in Table 6. We see that the MinMaxCut values obtained on LD-order are lower than that based on the q₂-order. The clustering accuracy also increases substantially. Note that the LD order can be recursively applied to the clustering results for further improvements.

TABLE 6
Improvements on accuracy (2nd and 3rd columns) due to the linkage
differential order over q₂-order. Improvements of J_{MMC}^{opt} values
are also shown. (4th and 5th columns).

| Dataset | Acc(q₂) | Acc(LD) | J_{MMC}^{opt} (q₂) | J_{MMC}^{opt} (LD) |
|---|---|---|---|---|
| NG1/NG2 | 97.2 ± 1.1% | 97.6 ± 0.8% | 0.698 | 0.694 |
| NG10/NG11 | 79.5 ± 11.0% | 87.2 ± 8.0% | 1.186 | 1.087 |
| NG18/NG19 | 83.6 ± 2.5% | 89.2 ± 1.8% | 1.126 | 1.057 |

### 2.9 Bi-Clustering: Simultaneous Clustering of Rows and Columns of a Contingency Table

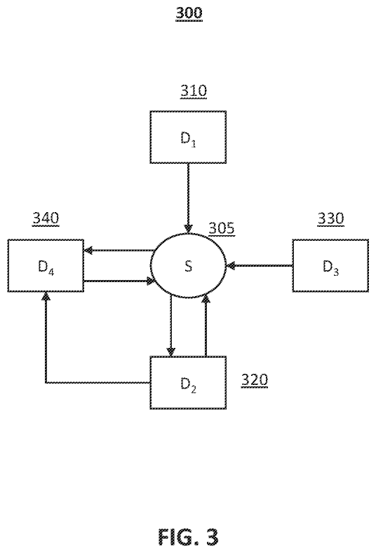

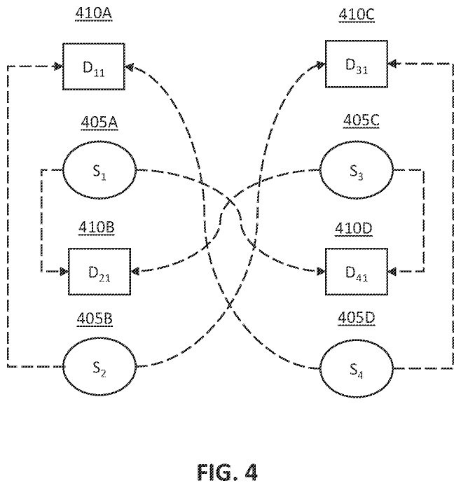

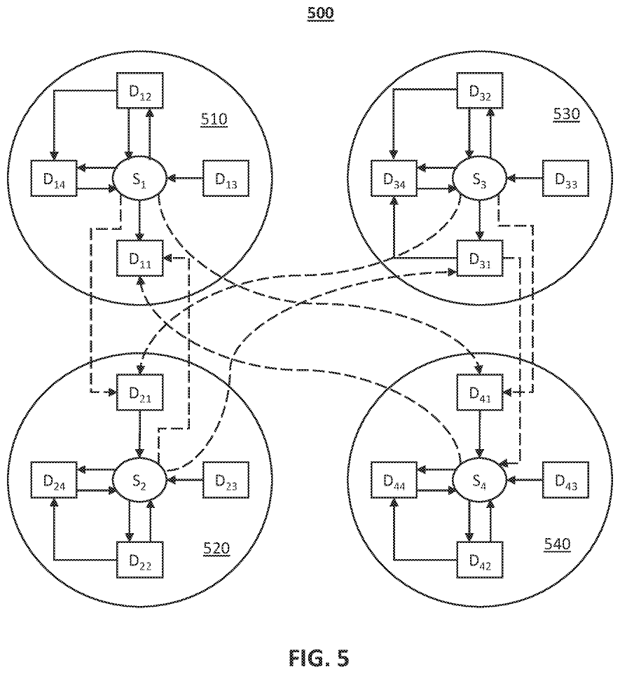

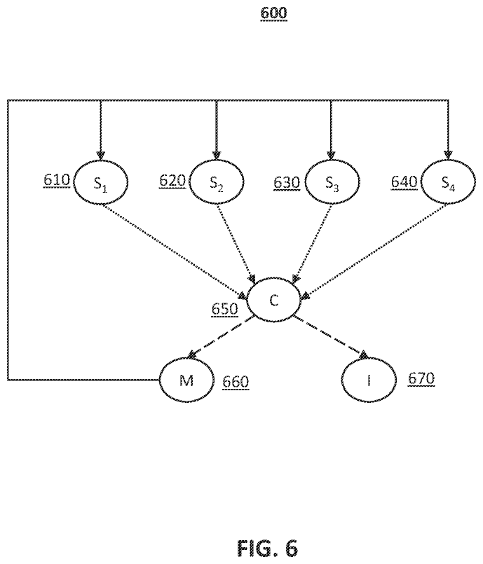

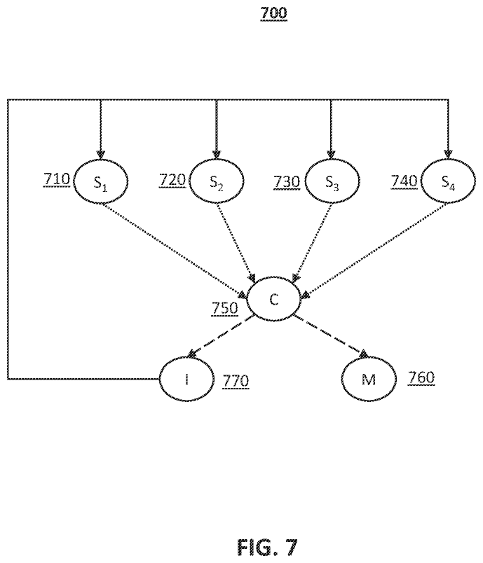

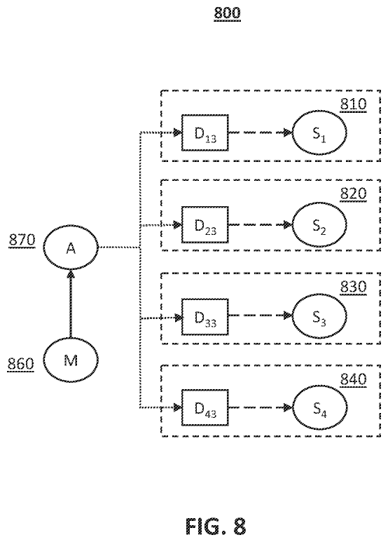

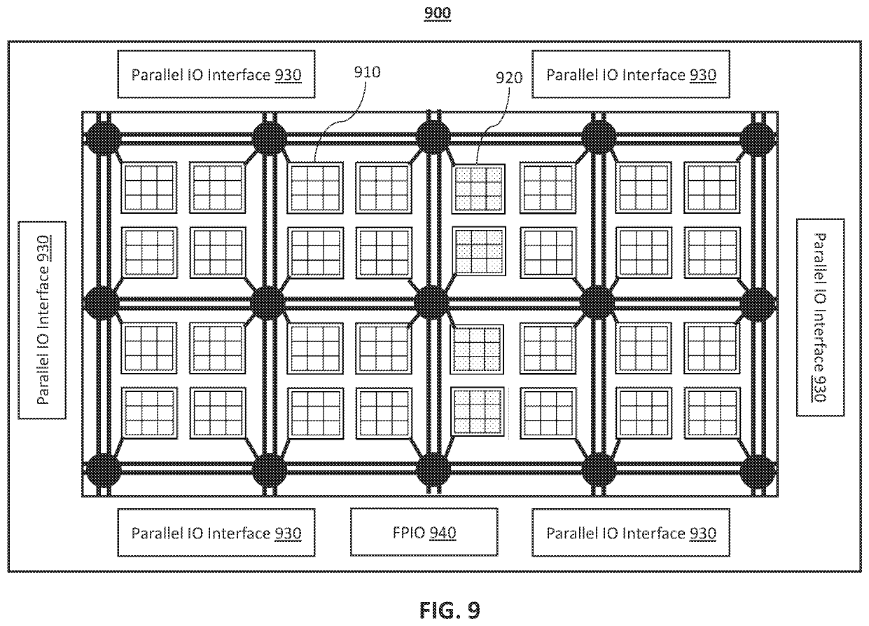

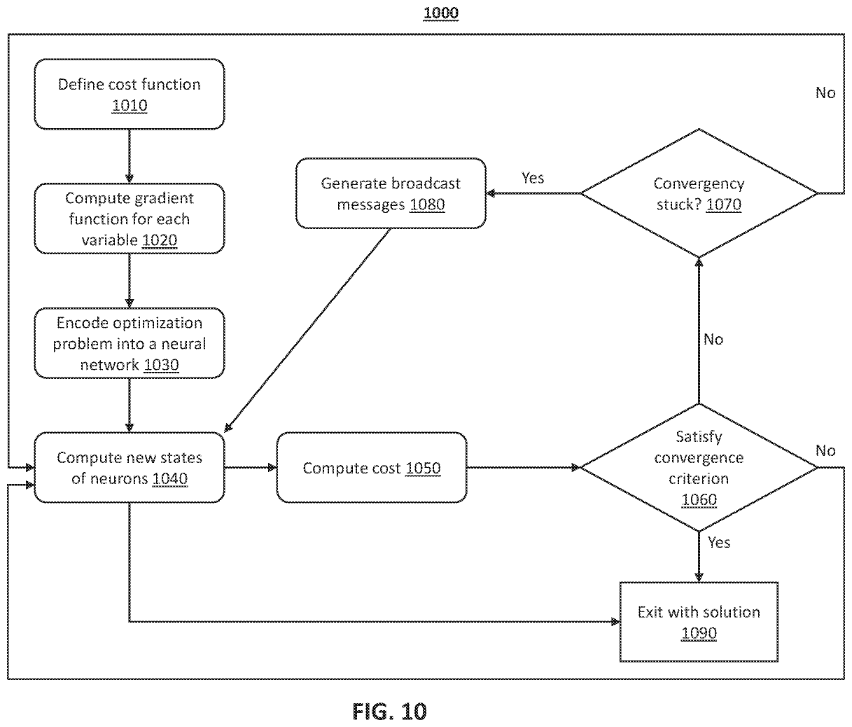

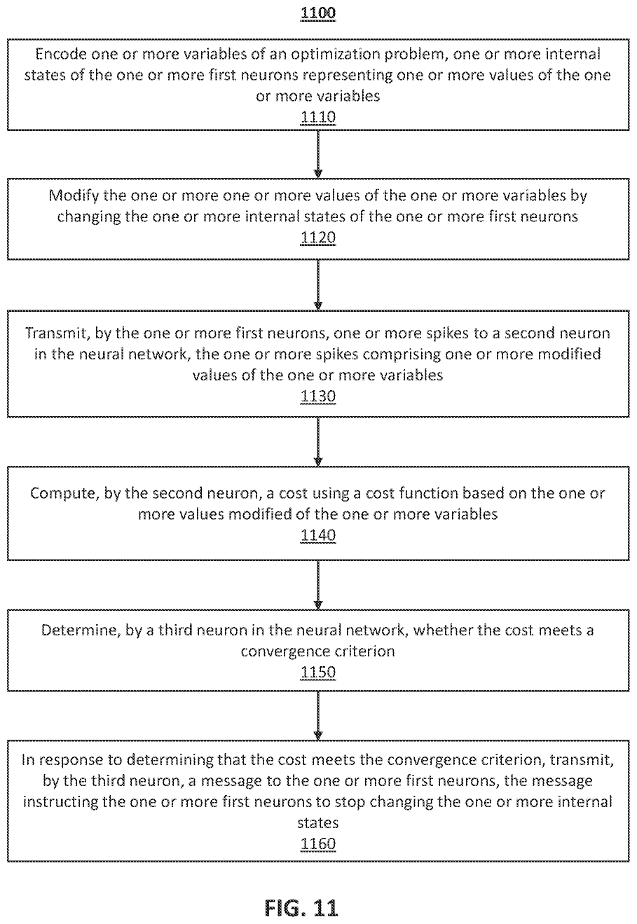

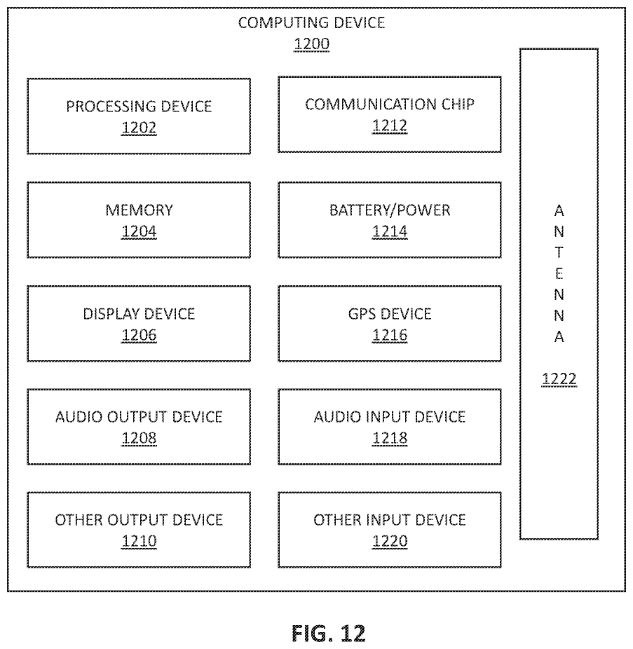

In many applications we look for inter-dependence among different aspects (attributes) of the same data objects. For example in text processing, a collection of documents is represented by a rectangular word-document association matrix, where each column represents a document and each row represents a word. The mutual interdependence reflect the fact that the content of a document is determined by the word occurrences, while the meaning of words can be inferred through their occurrences across different documents. The association data matrix P=(pᵢⱼ) typically has non-negative data entries. It can be studied as contingency table and viewed as a bipartite graph with P as its adjacency matrix as shown in FIG. 3. A row is represented by an r-node and a column by a c-node. Co-occurrence counts (probability) between row rᵢ and column cⱼ is represented by a weighted edge between rᵢ and cⱼ.

For a contingency table with m rows and n columns, we wish to partition the rows R into two clusters R₁, R₂ and simultaneously partition the columns C into two clusters C₁, C₂. Let s(Rₚ,C_{q})≡Σᵣ_{ᵢ}_{∈R}_{ₚ}Σ_{c}_{ⱼ}_{∈C}_{_{q}}pᵢⱼ. Clusterings are done such that between-cluster associations s(R₁, C₂), s(R₂, C₁) are minimized while within-cluster associations s(R₁, C₁), s(R₂, C₂) are maximized (see FIG. 3). These min-max clustering requirements lead to the following objective

$${J}_{MMC} ( {C}_{1} , {C}_{2} ; {R}_{1} , {R}_{2} ) = \frac{s ( {R}_{1} , {C}_{2} ) + s ( {R}_{2} , {C}_{1} )}{2 s ( {R}_{1} , {C}_{1} )} + \frac{s ( {R}_{1} , {C}_{2} ) + s ( {R}_{2} , {C}_{1} )}{2 s ( {R}_{2} , {C}_{2} )} \qquad ( 33 )$$

If n=m and pᵢⱼ=pⱼᵢ, Eq. (2.9) is reduced to Eq. (2). Let indicator vector f determine how to split R into R₁, R₂ and indicator vector g splits C into C₁, C₂:

$${f}_{i} = \{ \begin{matrix}a & if {r}_{i} ∈ {R}_{1} \\ - b & if {r}_{i} ∈ {R}_{2}\end{matrix} , {g}_{i} = \{ \begin{matrix}a & if {c}_{i} ∈ {C}_{1} \\ - b & if {c}_{i} ∈ {C}_{2}\end{matrix} \qquad ( 34 )$$

Let dᵢ^{r}=Σⱼ₌₁ⁿpᵢⱼ be row sums and dⱼ^{c}=Σᵢ₌₁^{m}pᵢⱼ be column sums. Form diagonal matrices Dᵣ=diag(d₁^{r}, . . . ,dₘ^{r}), D_{c}=diag(d₁^{c}, . . . ,dₙ^{c}). Define the scaled association matrix,

$$\hat{P} = {D}_{r}^{- 1 / 2} {PD}_{c}^{- 1 / 2} = {\sum }_{k = 1}^{min ( n , m )} {u}_{k} {λ}_{k} {v}_{k}^{T} , \qquad ( 35 )$$

with the singular value expansion explicitly written. We have the following:
Theorem 2.9. Simultaneous clustering of rows and columns based on the objective function Eq. (2.9), the continuous solution of the optimal clustering indicators are given by f₂=Dᵣ^{-1/2}u₂, and g₂=D_{c}^{-1/2}v₂.

The proof is an extension of Theorem 2.1 by treating the bipartite graph P as a standard graph [34] S=

$$( \begin{matrix}0 & P \\ {P}^{T} & 0\end{matrix} ) .$$

Details are skipped due to space limit. The use of SVD is also noted in [7].

### 3 K-Way MinMaxCut

So far we have focused on 2-way clustering. Now we extend to K-way cluster, K≥3. We define the objective function as the sum of all possible pairs of 2-way J_{MMC}:

$${J}_{MMC} ( {C}_{1} , … , {C}_{K} ) = {\sum }_{1 \leq p < q \leq K} {J}_{MMC} ( {C}_{p} , {C}_{q} ) = {\sum }_{k = 1}^{K} \frac{s ( {C}_{k} , {\overline{C}}_{k} )}{s ( {C}_{k} , {C}_{k} )} \qquad ( 36 )$$

where C̅ₖ=Σ_{p≠k}Cₚ is the complement of Cₖ. For comparison, RatioCut is extended to K-way clustering as [4]

$${J}_{rcut} ( {C}_{1} , … , {C}_{K} ) = {\sum }_{k = 1}^{K} \frac{s ( {C}_{k} , {\overline{C}}_{k} )}{\vert {C}_{k} \vert} , \qquad ( 37 )$$

and NormalizedCut is extended to K-way clustering as

$${J}_{ncut} ( {C}_{1} , … , {C}_{K} ) = {\sum }_{k = 1}^{K} \frac{s ( {C}_{k} , {\overline{C}}_{k} )}{{d}_{{C}_{k}}} = {\sum }_{k = 1}^{K} \frac{s ( {C}_{k} , {\overline{C}}_{k} )}{s ( {C}_{k} , {C}_{k} ) + s ( {C}_{k} , {\overline{C}}_{k} )} . \qquad ( 38 )$$

Note that for large K, s(Cₖ,C̅ₖ)=Σ_{p≠k}s(Cₚ,Cₖ) is likely to be larger than the within-cluster similarity s(Cₖ, Cₖ), i.e., MinMaxCut differs from NormalizedCut much more than in the K=2 case. From the analysis in section § 2.6, NormalizedCut is more likely to produce skewed cuts. Hence MinMaxCut is essential in K-way clustering.

The analysis of MinMaxCut, RatioCut, and NormalizedCut on random graph model as in section § 2.2 can be easily extended to K≥3 case, with identical conclusions. i.e., RatioCut and NormalizedCut show no size preferences, while on random graph model as in MinMaxCut favors balanced cut.

### 3.1 Cluster Balance: Size vs. Similarity

In the above on cluster balance, we are primarily concerned with cluster size, i.e., we desire the final clusters obtained have approximately same sizes,

|C₁|≅|C₂|≅ . . . ≅|C₈|. (39)

There is another form of cluster balance, as we discuss below. First of all, when minimizing J_{MMC}(C₁, . . . , C_{K}), there are K terms, all of which are positive. For J_{MMC} to be minimized, all terms should be of approximately same value: minimization does not favor the situation that one term is much larger than the rest. Thus we have

$$\frac{s ( {C}_{1} , {\overline{C}}_{1} )}{s ( {C}_{1} , {C}_{1} )} ≃ \frac{s ( {C}_{2} , {\overline{C}}_{2} )}{s ( {C}_{2} , {C}_{2} )} ≃ … ≃ \frac{s ( {C}_{K} , {\overline{C}}_{K} )}{s ( {C}_{K} , {C}_{K} )} \qquad ( 40 )$$

Now define the average between-cluster similarity s̅_{kk̅} and the average within-cluster similarity s̅ₖₖ;

$${\overline{s}}_{k \overline{k}} = \frac{s ( {C}_{k} , {\overline{C}}_{k} )}{\vert {C}_{k} \vert ( n - \vert {C}_{k} \vert )} , {s}_{kk} = \frac{s ( {C}_{k} , {C}_{k} )}{{\vert {C}_{k} \vert}^{2}} .$$

we have

$$\frac{{\overline{s}}_{1 \overline{1}} \vert ( n - \vert {C}_{1} \vert )}{{\overline{s}}_{11} \vert {C}_{1} \vert} ≃ \frac{{\overline{s}}_{2 \overline{2}} \vert ( n - \vert {C}_{2} \vert )}{{\overline{s}}_{22} \vert {C}_{2} \vert} ≃ … ≃ \frac{{\overline{s}}_{K \overline{K}} \vert n - \vert {C}_{K} \vert )}{{\overline{s}}_{KK} \vert {C}_{K} \vert}$$

Assume further that s̅_{11̅}≈ . . . ≈s̅_{kk̅} and also |Cₖ|<<n, we obtain

s₁₁|C₁|≅s₂₂|C₂|≅ . . . ≅s̅_{KK}|C_{K}|. (41)

We call this the similarity-weighted size balance. MinMaxCut is studied in a recent study on clustering objective functions [35], where for a dataset of articles about sports, for K=10 clustering, MinMaxCut produces clusters where the cluster sizes vary about a factor of 3.3 while the the similarity-weighted cluster size vary only a factor of 1.5 (example in Table 9 of [35]).

### 3.2 Bounds of K-Way MinMaxCut

The lower and upper bounds of J_{MMC} for K=2 (see section § 2.4) can be extended to K>2 case:
Theorem 3.2. For K-way MinMaxCut, we have the following bounds:

$$\frac{{K}^{2}}{1 + {ζ}_{2} + … + {ζ}_{K}} - K \leq {J}_{MMC}^{opt} ( {C}_{1} , … , {C}_{K} ) \leq \frac{{K}^{2} - K}{1 - K / n} \qquad ( 42 )$$

where ζ₂, . . . , ζ_{K} are the largest eigenvalues of Eq. (12).

Proof. The proof of the lower-bound relating to the first K eigenvectors is given in (which differ from those for K=2 in § 2.1 and § 2.4). The upper-bound is a simple extension from the K=2 case.

### 3.3 Initial K-Way MinMaxCut Clustering

K-way MinMaxCut is more complicated because there are multiple eigenvectors involved as explained by Theorem 3.2. Our approach is to first obtain approximate K initial clusters and then refine them. We discuss three methods for initial clusterings here.

Eigenspace K-means As provided by Theorem 3.2. cluster membership indicators of the K-way MinMaxCut are closely related to the first K eigenvectors. Thus we may use the projection in the K-dimensional eigenspace formed by the K eigenvectors and perform a K-means clustering. K-means cluster is a popular and efficient method. It minimizes the following clustering objective function

$${J}_{Kmeans} ( K ) = {\sum }_{k = 1}^{K} {\sum }_{i ∈ {C}_{k}} {( {x}_{i} - {c}_{k} )}^{2}$$

where xᵢ is projected feature vector in the eigenspace and cₖ=Σ_{i∈C}_{ₖ}xᵢ/|Cₖ|. This approach has been used in [4, 32, 33].

Divisive MinMaxCut. We start from the top, treating the whole dataset as a cluster. We repeatedly partition a current cluster into two via the 2-way MinMaxCut (a leaf node in a binary tree) until the number of clusters reaches a predefined value K, or some other stopping criteria are met. The crucial issue here is how to select the next candidate cluster to split. Details is explained in section § 4.

Agglomerative MinMaxCut. Here clusters are built from bottom up like conventional hierarchical agglomerative clustering. During each recursive procedure, we select two current clusters Cₚ and C_{q} and merge them to form a bigger cluster. The standard cluster selection methods include single linkage, complete linkage and average linkage. For MinMaxCut objective function, the MinMax linkage of Eq. (31) seems to be more appropriate. The cluster merging is repeated until a stopping condition is met.

### 3.4 K-Way MinMaxCut Refinement

Once the initial clustering (i.g., in divisive MinMaxCut) is computed, the refinements should be applied to improve the MinMaxCut objective function. The cluster refinement for K=2 discussed in § 2.7 may be extended to K>2 case by applying the 2-way linkage-based refinement pairwisely on all pairs of clusters.

On the other hand a direct k-way linkage-based refinement procedure may be adopted: Assume a node u currently belongs to cluster Cₖ. The linkage difference Δ [symbol] _{pq}(u)= [symbol] (u,Cₚ)− [symbol] (u,C_{q}) for all other K−1 clusters are computed. The smallest Δ [symbol] _{pq}(u) and the corresponding cluster indices are stored as an entry in a priority list. This is repeated for all nodes so every entry of the list is filled. The list is then sorted according to Δ [symbol] _{pq}(u) to obtain the final priority list. Following the list, nodes are then moved one after another to the appropriate clusters if the overall MinMaxCut objective is reduced. This completes one pass. Several passes may be necessary.

### 4 Divisive MinMaxCut

Divisive MinMaxCut is one practical algorithm for implementing K-way MinMaxCut via the hierarchical approach. It amounts to recursively select and split a cluster into two smaller ones in a top-down fashion until terminated. One advance of our divisive MinMaxCut over the traditional hierarchical clustering is that our methods have a clear objective function; Refinements of the clusters obtained from divisive process improve both the objective function and the clustering accuracy, as demonstrated in the experiments (§ 4.5). Divisive clustering depends crucially on the criterion of selecting the cluster to split.

### 4.1 Monotonicity of Cluster Objective Functions

It is instructive to see how clustering objective functions change with respect to the change of K, the number of clusters. Given the dataset and similarity measure (Euclidean distance in K-means and similarity graph weight in MinMaxCut), the global optimal value of the objective function is a function of K. An important property of these clustering objective functions is the monotonicity: as K increases K=2, 3, . . . , the MinMaxCut objective increases monotonically, while the K-means objective decreases monotonically. Thus there is a fundamental difference between the graph-based MinMaxCut and the Euclidean distance based K-means:
Theorem 4.1. Given the dataset and the similarity metric, as K increases, (a) the optimal value of the K-means objective function decreases monotonically:

J_{Kmeans}^{opt}(C₁, . . . ,C_{K})>J_{Kmeans}^{opt}(C₁, . . . ,C_{K},C_{K+1})

and (b) the optimal value of the MinMax Cut objective function increases monotonically:

J_{MMC}^{opt}(C₁, . . . ,C_{K})<J_{MMC}^{opt}(C₁, . . . ,C_{K},C_{K+1})

Proof. (a) is previously known. To prove (b), we assume A, B₁, B₂ are the optimal clusters for K=3 for a given dataset, and merge B₁, B₂, into a cluster. We compute the current J_{MMC}(A, B) and obtain

$${J}_{MMC}^{B - merge} ( A , B ) - {J}_{MMC}^{opt} ( A , {B}_{1} , {B}_{2} ) = \frac{s ( A , B )}{s ( B , B )} - \frac{s ( {B}_{1} , A ) + S ( {B}_{1} , {B}_{2} )}{s ( {B}_{1} , {B}_{1} )} - \frac{s ( {B}_{2} , A ) + s ( {B}_{2} , {B}_{1} )}{s ( {B}_{2} , {B}_{2} )} < 0 ,$$

noting s(A,B)=s(A,B₁)+(A,B₂), s(B₁,B₁)<s(B,B) and s(B₂,B₂)<s(B,B). The global minimum for K=2 must be lower than or equal to the particular instance of J_{MMC}(A, B). Thus we have

J_{MMC}^{opt}(A,B)≤J_{MMC}^{B-merge}(A,B)<J_{MMC}^{opt}(A, B₁,B₂).

Theorem 4.1 shows the difference between MinMaxCut objective and K-means objective. If we use the optimal value of the objective function to judge what is the optimal K, then K-means favors large number of clusters while MinMaxCut favors small number of clusters. The monotonic increase or decrease indicate that one cannot determine optimal K from the objective functions alone. Another consequence is that in the top-down divisive clustering, as clusters are split into more clusters, the K-means objective will steadily decrease while the MinMaxCut objective will steadily increase.

### 4.2 Cluster Selection

Suppose the dataset is clustered into m clusters in the divisive clustering. The question is how to select one of these m clusters to split.
(1) Size-priority cluster split. Select the cluster with largest size to split. This approach gives priority to produce size-balanced clusters. However, natural clusters are not restricted to the situation where each cluster has the same size. Thus this approach is not necessarily the optimal approach.
(2) Average similarity. Define average within-cluster similarity as s̅ₖₖ=sₖₖ/nₖ². We select the cluster with smallest s̅ₖₖ to split. A cluster Cₖ with large s̅ₖₖ implies that cluster members are strongly similar to each other, i.e., the cluster is compact. This criterion will increase the compactness of resulting clusters, which is a goal of min-max clustering principle.
(3) Cluster cohesion. We select the cluster p with the smallest cohesion among the current leaf clusters: p=arg minₖ hₖ. A cluster Cₖ with small cohesion hₖ implies it can be meaningfully split into two.
(4) Similarity-cohesion. Combination of cohesion with average similarity. We select the cluster p according to

$$p = arg {min}_{k} {\overline{s}}_{kk}^{γ} {h}_{k}^{( 1 - γ )} . \qquad ( 43 )$$

by setting γ=½. Note that setting γ=1, we get similarity criterion; setting γ=0, we get cohesion criterion.
(5) Temporary objective. All above cluster choices are based on cluster characteristics and do not involve the clustering objective Eq. (36). Since the goal of clustering is to optimize the objective function, we choose the cluster Cₖ such that the split of Cₖ leads to the smallest increase in the overall objective temporarily.

### 4.3 Stopping Criteria

In our experiments below, we terminate the divisive procedure when the number of leaf clusters reaches the predefined K. Another criterion is based on cluster cohesion. Theorem 4.1(b) indicates that as the divisive process continues and the number of leaf clusters increase, cluster cohesion of these leaf clusters increases. So a threshold on cohesion is a good stop criterion in applications.

### 4.4 Objective Function Saturation

If a dataset has K reasonably distinguishable clusters, these natural clusters could have many different shapes and sizes. But in many datasets, clusters overlap substantially and natural clusters cannot be defined clearly. Therefore, in general, a single (even the “best” if exists) objective function J can not effectively model the vast different types of datasets. For many datasets, as J is optimized, the accuracy (quality) of clustering is usually improved. But this works only up to a point. Beyond that, further optimization of the objective will not improve the quality of clustering because the objective function does not necessarily model the data in fine details. We here formalize this characteristics of clustering objective function as the saturation of objective function.

Definition. For a given measure η of quality of clustering (i.g. accuracy), the saturation objective, Jₛₐₜ, is defined to be the value when J is further optimized beyond Jₛₐₜ, η is no longer improved. We say η reaches its saturation value ηₛₐₜ.

Saturation accuracy is a useful concept and also a useful measure. Given a dataset with known class labels, there is a unique saturation accuracy for a clustering method. Saturation accuracy gives a good sense on how well the clustering algorithm will do on the given dataset.

In general we have to use the clustering method to do extensive clustering experiments to compute saturation accuracy. Here we propose an effective method to compute an upper bound on saturation accuracy for a clustering method. The method is the following. (a) Initialize with the perfect clusters constructed from the known class labels. At this stage, the accuracy is 100%. (b) Run the refinement algorithm on this clustering until convergence. (c) Compute accuracy and other measures. These values are the upper bounds on saturation values.

### 4.5 K-Way Clustering of Internet Newsgroups

We apply the divisive MinMaxCut algorithm to document clustering. We perform experiments on Internet newsgroup articles in 20 newsgroups. as in § 2.5. We focus on two sets of 5-cluster cases. The choice of K=5 is to have enough levels in the cluster tree; we avoid K=4,8 where the clustering results are less sensitive to cluster selection. The first dataset includes

| Dataset M5: | | Dataset L5: | |
|---|---|---|---|
| NG2: | comp.graphics | NG2: | comp.graphics |
| NG9: | rec.motorcycles | NG3: | comp.os.ms-windows |
| NG10: | rec.sport,baseball | NG8: | rec.autos |
| NG15: | sci.space | NG13: | sci.electronics |
| NG18: | talk.politics.mideast | NG19: | talk.politics.misc |

In M5, clusters overlap at medium level. In L5, overlaps among different clusters are large. From each set of newsgroups, we construct two datasets of different sizes: (A) randomly select 100 articles from each newsgroup. (B) randomly select 200, 140, 120, 100, 60 from the 5 newsgroups, respectively. Dataset (A) has clusters of equal sizes, which is presumably easier to cluster. Dataset (B) has clusters of significantly varying sizes, which is presumably difficult to cluster. Therefore, we have 4 newsgroup-cluster size combination categories
L5B: large overlapping clusters of balanced sizes
L5U: large overlapping clusters of unbalanced sizes
M5B: medium overlapping clusters of balanced sizes
M5U: medium overlapping clusters of unbalanced sizes

For each category, 5 different datasets randomly sampled from the newsgroups dataset; the divisive MinMaxCut algorithm is applied to each of them. The final results are the average of these 5 random datasets in each categories.

TABLE 7
Accuracy (in percentage) of divisive MinMaxCut clustering.
Errors in parenthesis.

| | M5B | M5U | L5B | L5U |
|---|---|---|---|---|
| Saturation | 92.5(2.0) | 91.7(1.6) | 81.4(2.1) | 79.0(4.4) |
| Size-P I | 82.8(3.4) | 77.1(10.8) | 67.2(2.9) | 62.9(6.7) |
| Size-P F | 91.8(1.7) | 81.7(9.9) | 71.8(4.8) | 68.4(1.9) |
| cohesion I | 66.1(10.6) | 75.6(13.8) | 46.3(11.6) | 50.9(14.7) |
| cohesion F | 73.0(10.8) | 78.8(13.2) | 49.6(5.3) | 58.1(13.8) |
| Tmp-obj I | 80.3(9.0) | 70.9(2.2) | 56.9(4.9) | 60.1(4.2) |
| Tmp-obj F | 87.0(11.6) | 75.0(1.3) | 58.7(5.6) | 68.8(2.8) |
| avg-sim I | 83.5(2.0) | 88.4(1.8) | 69.3(2.3) | 74.8(4.6) |
| avg-sim F | 91.7(1.1) | 91.7(1.3) | 72.4(4.1) | 74.1(2.5) |
| sim-coh I | 83.5(2.0) | 88.4(1.8) | 63.5(5.4) | 71.0(2.3) |
| sim-coh F | 91.8(1.2) | 91.0(1.0) | 67.1(8.0) | 72.6(2.3) |

The results of clustering on the four datasets are listed in Table 7. The upper bounds of saturation values are computed as described in § 4.4. Clustering results for each cluster selection method, size-priority (Size-P), average similarity (avg-sim), cohesion and similarity-cohesion (sim-coh) (see Eq. 43) and temporary objective (tmp-obj) are given in 2 rows: “I” (initial) are the results immediately after divisive cluster; “F” (final) are the results after two rounds of greedy refinements.

A number of observations can be made from these extensive clustering experiments. (1) The best results are obtained by average similarity cluster selection. This is consistent for all 4 datasets. (2) The similarity-cohesion cluster selection gives very good results, statistically no different from average similarity selection method. (3) Cluster cohesion alone as the selection method gives consistently poorest results. The temporary objective choice performs slightly better than cohesion criterion, but still substantially below avg-sim and sim-coh choices. These results are somehow unexpected. We checked the details of several divisive processes. The temporary objective and cohesion often lead to unbalanced clusters because of the greedy nature and unboundedness of these choices¹. (4) Size-priority selection method gives good results for datasets with balanced sizes, but not as good results for datasets with unbalanced cluster sizes. These are as expected. (5) The refinement based on MinMaxCut objective almost always improves the accuracy for all cluster selection methods on all datasets. This indicates the importance of refinements in hierarchical clustering. (6) Accuracies of the final clustering with avg-sim and sim-coh choices are very close to the saturation values, indicating the obtained clusters are as good as the MinMaxCut objective function could provide. (7) Dataset M5B has been studied in using K-means methods. The standard K-means method achievers an accuracy of 66%, while two improved K-means methods achieve 76-80% accuracy. ¹ A current cluster Cₖ is usually split into balanced clusters Cₖ₁, Cₖ₂ by the MinMaxCut. However, Cₖ₁ and Cₖ₂ may be quite smaller than other current clusters, because no mechanism exists in the divisive process to enforce balance across all current clusters. After several divisive steps, they could become substantially out of balance. In contrast, avg-similarity and size-priority choices prevent large unbalance to occur.

In comparison, the divisive MinMaxCut achieves 92% accuracy.

### 5 SUMMARY AND DISCUSSIONS

In this paper, we provide a comprehensive analysis on MinMaxCut spectral data clustering method. Comparing to earlier clustering methods, MinMaxCut has a strong cluster balancing feature (§ 2.2, § 2.6, § 3.1). The 2-way clustering can be computed easily while the K-way clustering requires a divisive clustering (§ 4).

In divisive MinMaxCut, cluster selections based on average similarity and cluster cohesion leads to balanced clusters in final stage and thus better clustering quality. Experiments on agglomerative MinMaxCut (as discussed in § 3.3) indicate [8] that agglomerative MinMaxCut is as good as the divisive MinMaxCut, both in clustering quality and in computational efficiency.

Our extensive experiments, on medium and large overlapping clusters with balanced and unbalanced cluster sizes, show that refinements of the clusters obtained in divisive and agglomerative MinMaxCut always improve clustering quality, strongly indicating the min-max clustering objective function captures the essential features of clusters in a wide range of situations. This supports our emphasis on the objective function optimization based approach.

Since the cluster refinement is an essential part of objective function based approach, efficient refinement algorithms are needed. The refinement methods discussed in § 2.7, § 2.8, § 3.4 are of order O(n²) complexity. An efficient refinement algorithm like Fiduccia-Mattheyses linear time heuristic [15] is highly desirable.

A counter point to the objective function optimization approach is the objective function saturation, i.e., objective optimization is useful only up to a certain point (see § 4.4). Therefore finding a universal clustering objective function is another important direction of research. On the order hand, the saturation values of accuracy or objective functions can be used as a good assessment of the effectiveness of the clustering method as shown in Table 7. However, this point does not favor the procedure oriented clustering approach, where the lack of objective function makes the self-consistent assessment impossible; justifications of the method are empirical.

### REFERENCES

[1] J. D. Banfield and A. E. Raftery. Model-based gaussian and non-gaussian clustering. Biometrics, 49:803-821, 1993.
[2] D. Boley. Principal direction divisive partitioning. Data mining and knowledge discovery, 2:325-344, 1998.
[3] B. Bollobas. Random Graphs. Academic Press, 1985.
[4] P. K. Chan, M. Schlag, and J. Y. Zien. Spectral k-way ratio-cut partitioning and clustering. IEEE Trans. CAD-Integrated Circuits and Systems, 13:1088-1096, 1994.
[5] C.-K. Cheng and Y. A. Wei. An improved two-way partitioning algorithm with stable performance. IEEE. Trans. on Computed Aided Design, 10:1502-1511, 1991.
[6] F. R. K. Chung. Spectral Graph Theory. Amer. Math. Society, 1997.
[7] I. S. Dhillon. Co-clustering documents and words using bipartite spectral graph partitioning. Proc. ACM Int'l Conf Knowledge Disc. Data Mining (KDD 2001), 2001.
[8] C. Ding and X. He. Cluster merge and split in hierarchical clustering. Proc. IEEE Int'l Conf. Data Mining, pages 139-146, 2002.
[9] C. Ding. X. He, and H. Zha. A spectral method to separate disconnected and nearly-disconnected web graph components. In Proc. ACM Int'l Conf Knowledge Disc. Data Mining (KDD), pages 275-280, 2001.
[10] C. Ding, X. He, H. Zha, M. Gu, and H. Simon. A min-max cut algorithm for graph partitioning and data clustering. Proc. IEEE Int'l Conf. Data Mining, 2001.
[11] W. E. Donath and A. J. Hoffman. Lower bounds for partitioning of graphs. IBM J. Res. Develop., 17:420-425, 1973.
[12] R. V. Driessche and D. Roose. An improved spectral bisection algorithm and its application to dynamic load balancing. Parallel Computing, 21:29-48, 1995.
[13] P. Drineas, A. Frieze, R. Kannan, S. Vempala, and V. Vinay. Clustering in large graphs and matrices. In Proc. 19th ACM-SIAM Symposium on Discrete Algorithms, 1999.
[14] R. O. Duda, P. E. Hart, and D. G. Stork. Pattern Classification, 2nd ed. Wiley, 2000.
[15] C. M. Fiduccia and R. M. Mattheyses. A linear time heuristic for improving network partitions. Proc. 19th IEEE Design Automation Conference, pages 175-181, 1982.
[16] M. Fiedler. Algebraic connectivity of graphs. Czech. Math. J., 23:298-305, 1973.
[17] M. Fiedler. A property of eigenvectors of non-negative symmetric matrices and its application to graph theory. Czech. Math. J., 25:619-633, 1975.
[18] M. Gu, H. Zha, C. Ding, X. He, and H. Simon. Spectral relaxation models and structure analysis for k-way graph clustering and bi-clustering. Penn State Univ Tech Report CSE-01-007, 2001.
[19] L. Hagen and A. B. Kahog. New spectral methods for ratio cut partitioning and clustering. IEEE. Trans. on Computed Aided Design, 11:1074-1085, 1992.
[20] J. Han and M. Kamber. Data Mining: Concepts and Techniques. Morgan Kaufmann, 2000.
[21] J. Hartigan. Clustering Algorithms. John Wiley & Sons, 1975.
[22] J. A. Hartigan and M. A. Wang. A K-means clustering algorithm. Applied Statistics, 28:100-108, 1979.
[23] T. Hastie, R. Tibshirani, and J. Friedman. Elements of Statistical Learning. Springer Verlag, 2001.
[24] A. K. Jain and R. C. Dubes. Algorithms for clustering data. Prentice Hall, 1988.
[25] S. P. Lloyd. Least squares quantization in pcm. Bell Telephone Laboratories Paper, Murray Hill, 1957.
[26] J. MacQueen. Some methods for classification and analysis of multivariate observations. Proc. 5th Berkeley Symposium, pages 281-297, 1967.
[27] A. McCallum. Bow: A toolkit for statistical language modeling, text retrieval, classification and clustering. http://www.cs.cmu.edu/mccallum/bow, 1996.
[28] G. McLachlan and T. Krishnan. The EM Algorithm and Extensions. John Wiley, 1997.
[29] A. Y. Ng, M. I. Jordan, and Y. Weiss. On spectral clustering: Analysis and an algorithm. Proc. Neural Info. Processing Systems (NIPS 2001), 2001.
[30] B. N. Parlett. The Symmetric Eigenvalue Problem. SIAM Press, 1998.
[31] A. Pothen, H. D. Simon, and K. P. Liou. Partitioning sparse matrices with egenvectors of graph. SIAM Journal of Matrix Anal. Appl., 11:430-452, 1990.
[32] J. Shi and J. Malik. Normalized cuts and image segmentation. IEEE. Trans. on Pattern Analysis and Machine Intelligence. 22:888-905, 2000.
[33] H. Zha, C. Ding, M. Gu, X. He, and H. D. Simon. Spectral relaxation for k-means clustering. Proc. Neural Info. Processing Systems (NIPS 2001), 2001.
[34] H. Zha, X. He, C. Ding, M. Gu, and H. D. Simon. Bipartite graph partitioning and data clustering. Proc. Int'l Conf. Information and Knowledge Management (CIKM 2001), 2001.
[35] Y. Zhao and G. Karypis. Criterion functions for document clustering: Experiments and analysis. Univ. Minnesota, CS Dept. Tech Report #01-40, 2001.

1. A computer-implemented method, comprising:
encoding, by one or more first neurons in a neural network, one or more variables of an optimization problem, one or more states of the one or more first neurons representing one or more values of the one or more variables;
modifying the one or more values of the one or more variables by changing the one or more states of the one or more first neurons;
transmitting, by the one or more first neurons, one or more spikes to a second neuron in the neural network, the one or more spikes comprising one or more modified values of the one or more variables;
computing, by the second neuron, a cost using a cost function based on the one or more values modified of the one or more variables;
determining, by a third neuron in the neural network, whether the cost meets a convergence criterion; and
in response to determining that the cost meets the convergence criterion, transmitting, by the third neuron, a message to the one or more first neurons, the message instructing the one or more first neurons to stop changing the one or more states.

2. The computer-implemented method of claim 1, wherein:
a first neuron comprises a spiking unit, a first unit, and a second unit,
the spiking unit receives a first input from the first unit and receives a second input from the second unit, and
the spiking unit updates a state of the first neuron based on the first input and the second input.

3. The computer-implemented method of claim 2, wherein:
the first unit computes the first input based on data received from another first neuron, and
the second input from the second neuron is a prior state of the first neuron.

4. The computer-implemented method of claim 2, wherein:
the first neuron further comprises an additional unit, and
the additional unit, based on a message from the third neuron, resets the state of the first neuron to an initialized state of the first neuron.

5. The computer-implemented method of claim 2, wherein:
the first neuron further comprises an additional unit,
the additional unit computes a time-weighted average of states of the first neuron, and
the spiking unit sends out a spike encoding the state of the first neuron based on a determination that the state of the first neuron is equal to or greater than the time-weighted average.

6. The computer-implemented method of claim 1, wherein the message further instructs the one or more first neurons to send a processing unit the one or more spikes as a solution to the optimization problem.

7. The computer-implemented method of claim 1, further comprising:
in response to determining that the cost fails to meet the convergence criterion, transmitting, by the third neuron, a different message to one or more units in the one or more first neurons, the different message instructing the one or more units in the one or more first neurons to further modify the one or more values of the one or more variables by further changing the one or more states of the one or more first neurons.

8. The computer-implemented method of claim 1, further comprising:
determining, by a fourth neuron in the neural network, whether a stalling period threshold is reached based on a spike from the third neuron; and
after determining that stalling period threshold is reached, instructing, by the fourth neuron, the third neuron to transmit a different message to the one or more first neurons, the different message instructing the one or more first neurons to change the one or more modified values of the one or more variables back to the one or more values of the one or more variables.

9. The computer-implemented method of claim 1, wherein determining whether the cost meets a convergence criterion comprises:
determining whether the cost is equal to or lower than a target cost.

10. The computer-implemented method of claim 1, wherein determining whether the cost meets a convergence criterion comprises:
determining whether a number of steps in which the one or more first neurons change the one or more states exceeds a threshold number.

11. One or more non-transitory computer-readable media storing instructions executable to perform operations, the operations comprising:
encoding, by one or more first neurons in a neural network, one or more variables of an optimization problem, one or more states of the one or more first neurons representing one or more values of the one or more variables;
modifying the one or more values of the one or more variables by changing the one or more states of the one or more first neurons;
transmitting, by the one or more first neurons, one or more spikes to a second neuron in the neural network, the one or more spikes comprising one or more modified values of the one or more variables;
computing, by the second neuron, a cost using a cost function based on the one or more values modified of the one or more variables;
determining, by a third neuron in the neural network, whether the cost meets a convergence criterion; and
in response to determining that the cost meets the convergence criterion, transmitting, by the third neuron, a message to the one or more first neurons, the message instructing the one or more first neurons to stop changing the one or more states.

12. The one or more non-transitory computer-readable media of claim 11, wherein:
a first neuron comprises a spiking unit, a first unit, and a second unit,
the spiking unit receives a first input from the first unit and receives a second input from the second unit, and
the spiking unit updates a state of the first neuron based on the first input and the second input.

13. The one or more non-transitory computer-readable media of claim 12, wherein:
the first unit computes the first input based on data received from another first neuron, and
the second input from the second neuron is a prior state of the first neuron.

14. The one or more non-transitory computer-readable media of claim 12, wherein:
the first neuron further comprises an additional unit, and
the additional unit, based on a message from the third neuron, resets the state of the first neuron to an initialized state of the first neuron.

15. The one or more non-transitory computer-readable media of claim 12, wherein:
the first neuron further comprises an additional unit,
the additional unit computes a time-weighted average of states of the first neuron, and
the spiking unit sends out a spike encoding the state of the first neuron based on a determination that the state of the first neuron is equal to or greater than the time-weighted average.

16. The one or more non-transitory computer-readable media of claim 11, wherein the message further instructs the one or more first neurons to send a processing unit the one or more spikes as a solution to the optimization problem.

17. The one or more non-transitory computer-readable media of claim 11, wherein the operations further comprise:
in response to determining that the cost fails to meet the convergence criterion, transmitting, by the third neuron, a different message to the one or more first neurons, the different message instructing the one or more first neurons to further modify the one or more values of the one or more variables by further changing the one or more states of the one or more first neurons.

18. The one or more non-transitory computer-readable media of claim 11, wherein the operations further comprise:
determining, by a fourth neuron in the neural network, whether a stalling period threshold is reached based on a spike from the third neuron; and
after determining that stalling period threshold is reached, instructing, by the fourth neuron, the third neuron to transmit a different message to the one or more first neurons, the different message instructing the one or more first neurons to change the one or more modified values of the one or more variables back to the one or more values of the one or more variables.

19. An apparatus, comprising:
a computer processor for executing computer program instructions; and
a non-transitory computer-readable memory storing computer program instructions executable by the computer processor to perform operations comprising:
encoding, by one or more first neurons in a neural network, one or more variables of an optimization problem, one or more states of the one or more first neurons representing one or more values of the one or more variables,
modifying the one or more values of the one or more variables by changing the one or more states of the one or more first neurons,
transmitting, by the one or more first neurons, one or more spikes to a second neuron in the neural network, the one or more spikes comprising one or more modified values of the one or more variables,
computing, by the second neuron, a cost using a cost function based on the one or more values modified of the one or more variables,
determining, by a third neuron in the neural network, whether the cost meets a convergence criterion, and
in response to determining that the cost meets the convergence criterion, transmitting, by the third neuron, a message to the one or more first neurons, the message instructing the one or more first neurons to stop changing the one or more states.

20. The apparatus of claim 19, wherein:
a first neuron comprises a spiking unit, a first unit, and a second unit,
the spiking unit receives a first input from the first unit and receives a second input from the second unit, and
the spiking unit updates a state of the first neuron based on the first input and the second input.
